(19) United States
(12) Patent Application Publication
(10) Pub. No.: US 2006/0114323 A1
(43) Pub. Date: Jun. 1, 2006

(54) Method for state-dependent safeguarding of machines and apparatus for implementing the method

(75) Inventors: Ulrich Grimm, Dielheim (DE); Carsten Huschle, Rettigheim (DE); Thomas Wolf, Karlsruhe (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/281,350

(22) Filed: Nov. 17, 2005

(30) Foreign Application Priority Data
Nov. 17, 2004 (DE) 10 2004 055 229.0

(51) Int. Cl. H04N 7/18; H04N 9/47

(52) U.S. Cl. 348/143

(57) ABSTRACT

A method and an apparatus safeguard hazardous areas in machines in the printing industry. Such a hazardous area is monitored by at least one sensor that is suitable for identifying objects penetrating into the hazardous area and is connected to a machine control system. When an object penetrates into the hazardous area, the object is identified through the use of the sensor and the machine control system acts on the state of the hazardous area of the machine on the basis of the identification and the respective operating state of the machine.

### BACKGROUND OF THE INVENTION

### Field of the Invention

The present invention relates to a method and an apparatus for safeguarding hazardous areas in machines. Such a hazardous area is monitored by at least one sensor that is suitable for identifying objects penetrating into the hazardous area and is connected to a machine control system.

Methods and protective apparatus are known with which machines can be safeguarded. It is accordingly possible to draw a distinction between permitted and non-permitted penetration of specific objects. An apparatus of that type which is disclosed by U.S. Patent Application Publication No. US 2003/0164447 A1 safeguards the hazardous area of a metal-processing machine. In that case, the opening to the hazardous area of the metal-processing machine is initially safeguarded through the use of a light barrier. The light barrier is capable of distinguishing between the penetration of permitted workpieces and forbidden body parts of the operating personnel. The distinction is drawn in that the workpieces, as they pass through the light barrier, darken only one light beam because of their low thickness, while the limbs of the operating personnel, due to their larger dimensions, darken at least two lights beams beside each other. As long as only one light beam is darkened, the metal-processing machine remains in the quite normal operating state, whereas when body parts of the operating personnel penetrate, the machine is switched off immediately.

However, in the case of hazardous areas in printing presses, such a type of safeguard is not expedient since there, in the area of the delivery and of the feeder of a sheet-fed printing press, under specific conditions, it is necessary for the operating personnel to reach into the hazardous areas during the operation. However, such a penetration is not permitted by the apparatus according to the prior art.

### SUMMARY OF THE INVENTION

It is accordingly an object of the invention to provide a method for state-dependent safeguarding of hazardous areas of machines and an apparatus for implementing the method, which overcome the hereinafore-mentioned disadvantages of the heretofore-known methods and apparatus of this general type, which are capable of distinguishing between permitted and non-permitted penetrations into the hazardous area and which also permit the penetration of actually non-permitted objects into the hazardous area under specific conditions.

With the foregoing and other objects in view there is provided, in accordance with the invention, a method for safeguarding hazardous areas in machines, which comprises monitoring a hazardous area with at least one sensor for identifying objects penetrating into the hazardous area. The at least one sensor identifies when an object penetrates into the hazardous area. A machine control system communicates with the at least one sensor. The machine control system acts on the state of the hazardous area of the machine on the basis of the identification and the respective operating state of the machine.

With the objects of the invention in view, there is also provided an apparatus for safeguarding hazardous areas in machines. The apparatus comprises at least one sensor monitoring the hazardous area for identification of objects penetrating into the hazardous area. The at least one sensor identifies when an object penetrates into the hazardous area. A machine control system communicates with the at least one sensor. The machine control system acts on the state of the hazardous area of the machine on the basis of the identification and the respective operating state of the machine.

In order to safeguard hazardous areas in machines, such areas are monitored by a sensor which is capable of identifying objects penetrating into the hazardous area. It is therefore in principle possible to distinguish between objects which may penetrate into the hazardous area and forbidden objects. The permitted and forbidden objects are divided into two classes for this purpose, such that each identified object falls into either the permitted or the forbidden class. As long as a permitted object penetrates into the hazardous area such as, for example, when a new sheet stack is introduced into the feeder, the machine continues to run quite normally. If a non-permitted object penetrates into the hazardous area then, according to the prior art, the machine would be switched off immediately. According to the present invention, however, the operating state of the machine is now also taken into account appropriately, so that the machine is actually switched off only when, due to the current operating state, there is also an acute risk to the operating personnel in the hazardous area of the machine. For instance, if movable parts in the hazardous area which represent a crushing hazard for the operating personnel are stopped in any case due to the current operating state, the machine itself does not have to be stopped. The protective apparatus therefore always takes into account the acute potential for injury to the operating personnel and takes the machine out of operation only when the potential for injury in the hazardous area is also actually there. This increases the availability of the machine.

In accordance with another mode of the invention, the sensor is suitable for distinguishing between human body parts and objects. With this refinement of the invention, it is ensured that, in the case of an acute risk in the hazardous area in the event of penetration of human body parts, the machine is immediately changed to a safe state, while the introduction of objects, such as during a stack change in the feeder or delivery of a printing press, does not trigger a machine stoppage.

In accordance with a further mode of the invention, three-dimensional scanning of the object penetrating into the hazardous area is advantageously carried out through the use of the sensor. Such a sensor is represented by a 3-D camera, which permits the penetrating object to be identified unambiguously due to its external shape. Through the use of such a 3-D camera, it is also possible to register the penetration depth of the penetrating object as well, so that the machine is only shut down when the object has penetrated into the hazardous area to such an extent that there is an immediate risk. In addition, in this way, depending on the respective operating state of the machine and the different potential hazards resulting therefrom, different penetration depths for different objects can be permitted. In this case, further classes can be added to the two classes of permitted and non-permitted objects. In those further classes, the permitted and non-permitted objects are further divided up in relation to their penetration depth as a function of the respective machine state. For instance, in the feeder area, in the case of a stack carrier board with the remainder of a stack which is located in the upper area, the lower area can be cleared for the operating personnel to enter until the stack carrier board moves down again. If the downward movement of the stack carrier board is initiated, the machine is in another operating state again, which effects the immediate shutdown of the machine should operating personnel still be found underneath the stack carrier board of the feeder stack.

In accordance with an added, simplified mode of the invention, the sensor is a light barrier or a light curtain. In this case, a light curtain is understood to mean a plurality of light barriers disposed in one plane. With these light barriers, it is also possible to perform at least coarse division between permitted and non-permitted objects. Of course, during the use of the light barriers, care must be taken to ensure that objects and human body parts are always kept satisfactorily away from one another, so that the human body parts are always assigned to the non-permitted objects.

In accordance with an additional mode of the invention, the machine control system acts on hazardous parts of the machine in the hazardous area. In this case, is not necessary for the entire machine to be stopped if a non-permitted object has penetrated into the hazardous area. Instead, the hazardous parts of the machine giving rise to the risk of injury are either stopped or brought into a safe state, so that the non-permitted object can no longer come into contact with the hazardous parts and in this way is protected against injury.

In accordance with yet another mode of the invention, the safeguarding of the hazardous area is carried out through the use of the machine control system acting on the basis of the penetration movement of the identified object determined through the use of the sensor. Through the use of the sensor, it is possible to register the movement of the object penetrating into the hazardous area. If the object moves toward the hazardous parts of the machine, then the machine must be switched off or put into a safe state. However, if the direction of movement of the object should change before the occurrence of an acute risk of injury so that the movement leads away from the hazardous parts of the machine, then the machine does not have to be switched off and instead can continue to run.

In accordance with yet a further mode of the invention, in addition to the direction of movement, the speed of penetration of the identified object can also be taken into account. If the object penetrates into the hazardous area at high speed, the hazardous parts of the machine or the entire machine have to be switched off correspondingly faster than if the object approaches at a slower speed. The reason for this is that, even in the case in which the machine is switched off immediately and in the event of any braking of the moving hazardous parts which may be carried out, a certain run-on and braking time as well as a reaction time due to the inertia of rotating masses or moving masses in the machine have to be taken into account.

In accordance with a concomitant mode of the invention, the safeguarding of the hazardous area is carried out by the machine control system acting on the basis of the shape of the identified object detected through the use of the sensor. It is possible, for example, to distinguish between objects and human limbs by using the shape of the identified object. In addition, objects can also be divided up into different classes so that, for example, the introduction of a stack into the feeder of a sheet-fed printing press is permitted, but the intentional introduction of a tool by the operating personnel is also detected and leads to a stoppage of the machine. In this case, the operating personnel are not only protected against hazards which can occur when tools encounter moving parts of the machine, for example as a result of the tool being thrown out, but at the same time the mechanism of the machine, which could otherwise be jammed as a result of the introduction of the tool, is also protected. In this case, the protective apparatus therefore serves not only to protect the operating personnel but also to protect the machine.

Other features which are considered as characteristic for the invention are set forth in the appended claims.

Although the invention is illustrated and the invention is described herein as embodied in a method for state-dependent safeguarding of machines and an apparatus for implementing the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE INVEMTION

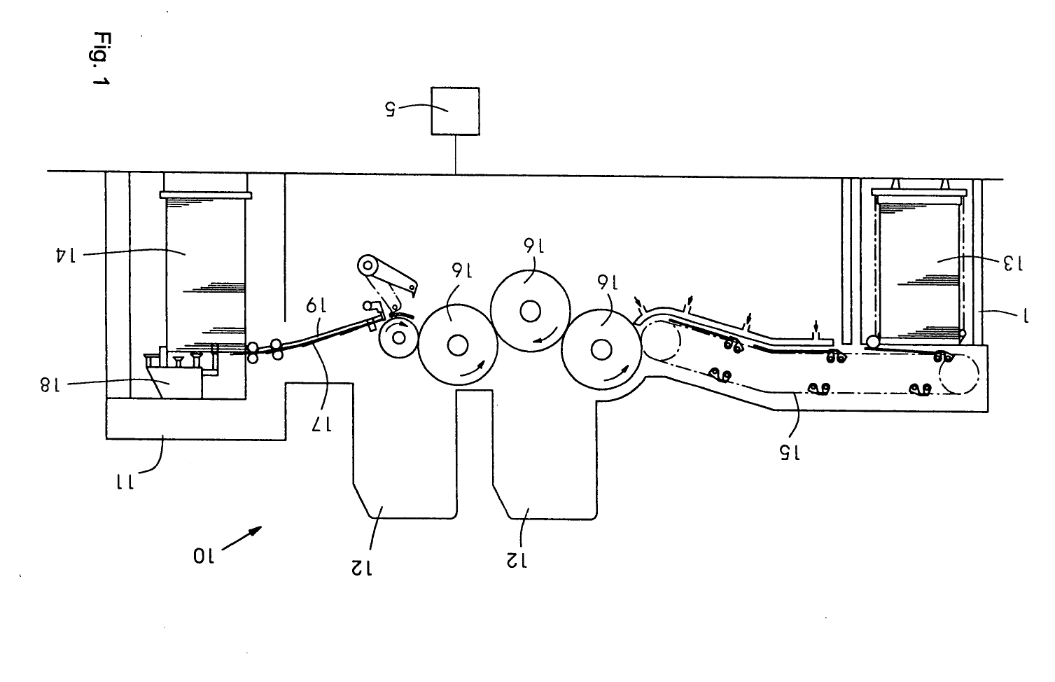

FIG. 1 is a diagrammatic, side-elevational view of a sheet-fed rotary printing press having a feeder and a delivery;

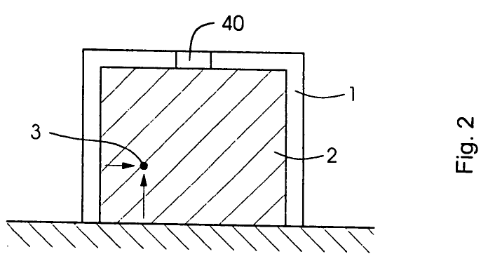

FIG. 2 is an enlarged, fragmentary, partly-sectional, elevational view of a monitored hazardous area on the delivery; and

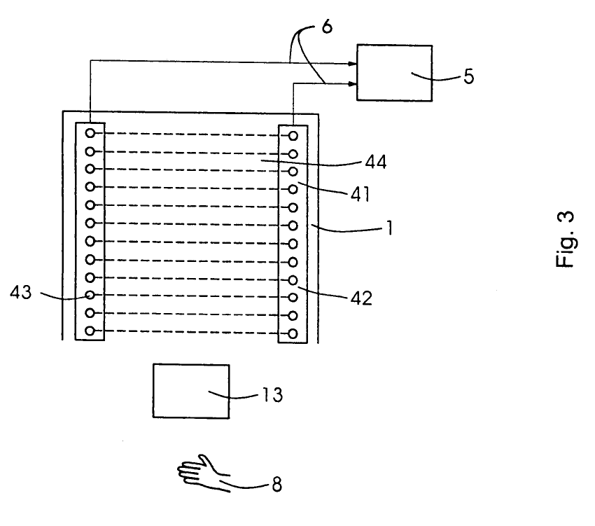

FIG. 3 is an elevational view illustrating the use of a light barrier for monitoring the hazardous area on the delivery of a printing press.

### DESCRIPTION OF THE PREFERRED EMBODIMENTS

Referring now to the figures of the drawings in detail and first, particularly, to FIG. 1 thereof, there is seen a printing press 10, which includes a sheet feeder 11, two printing units 12 and a sheet delivery 1. Sheets 17 are removed from a feeder stack 14 in the sheet feeder 11 through the use of a suction head 18 and separated and are then fed over a suction tape table 19 to the printing units 12. The sheets 17 are transported through the printing units 12 through the use of transport cylinders 16 and, in the printed state, are transferred to the delivery 1. The transport in the delivery 1 from the last printing unit 12 as far as a delivery stack 13 in this case is performed by gripper chains 15, which grip the sheet 17 on at least one side and deposit it on the delivery stack 13. During operation, the printing press 10 is controlled by an electronic machine control system 5, which implements entries made by operating personnel.

On one hand, both the sheet feeder 11 and the sheet delivery 1 constitute a considerable source of hazards, since there is a considerable risk of injury to the operating personnel due to the moving components. On the other hand, the hazardous areas in the interior of the sheet feeder 11 and the sheet delivery 1 cannot simply be blocked completely against interventions by mechanical protective apparatus, since certain interventions are required in order to operate the printing press 10. For example, in the sheet feeder 11, after the feeder stack 14 has been used up, an empty pallet must be removed and a new feeder stack 14 introduced. The feeder stack 14 can be changed during continuous operation in order not to interrupt the operation of the printing press 10. This is similarly true of the delivery 1, at which the delivery stack 13 with the printed sheets has to be removed at specific time intervals in order to create space for new incoming printed sheets 17.

In addition, the operating personnel must be provided with the possibility of performing inspections of the printed image on the sheet 17 in the delivery stack 13 at specific time intervals. For this purpose, individual sheets 17 are normally removed from the delivery stack 13 by the operating personnel and assessed on a test bench. It must therefore be possible, during the operation of the printing press 10, to reach at least into specific regions of the feeder 11 and of the delivery 1. For safety reasons, however, the hazardous areas in the feeder 11 and in the delivery 1 must be safeguarded appropriately.

FIG. 2 shows one possible way of safeguarding the hazardous area in the delivery 1. The possible way shown in FIG. 2 of safeguarding one side of the sheet delivery 1 can, of course, be applied to all four sides of the sheet delivery 1 and likewise to the sheet feeder 11 or to other openings of the printing press 10. According to FIG. 2, the sheet delivery 1 has at least one opening 2, through which the operating personnel can reach into the hazardous area in the interior of the delivery 1. In the case of correspondingly large printing presses 10, there is even the possibility that the operating personnel can enter the hazardous area with their whole body, and there is then an acute risk to life in that case. For this reason, the access opening 2 is monitored through the use of a sensor 40 in order to detect the penetration of objects or persons into the delivery 1. In FIG. 2, the sensor 40 is constructed as a type of radar, which not only detects the penetration into the hazardous area but also a precise location 3 of the penetration into the hazardous area. For example, the location 3 in FIG. 2 indicates, for instance, the location of penetration of an arm of a person who wishes to reach into the interior of the delivery 1. If there are no elements of the delivery 1 which endanger the operating personnel immediately at the location of the intervention 3, the printing press 10 does not necessarily have to be switched off. However, if the intervention is made at another location, for example in the upper area of the opening 2, in which there is the risk that the person reaching in could bring their finger and their arm into the region of the hazardous gripper chains 15, the machine 10 is stopped immediately.

In addition, the operating state of the machine 10 is also taken into account. For example, a penetration location 3 in the vicinity of the gripper chains 15 only constitutes a hazard when the gripper chains are also moving. If no sheets 17 are being conveyed, the gripper chains 15 are stationary and a penetration location 3 in the vicinity of the gripper chains 15 does not lead to a hazardous situation for operating personnel penetrating there, for which reason a machine stoppage is not necessary in this case.

In an alternative refinement, provision can also be made for only the gripper chains 15 in the delivery to be switched off, if they have a separate drive. If the machine control system 5 cannot detect any immediate hazard to the operating personnel on the basis of the penetration location 3 determined by the sensor 40, an acoustic or visual alarm can nevertheless be output in order to refer the penetration into the hazardous area to the operating personnel.

Instead of the sensor 40, a 3-D camera can also be installed, which monitors the cross section of the opening 2 and the interior of the hazardous area. The camera can determine the shape and therefore the identification of a penetrating object 8, 13 shown in FIG. 3. In addition, the camera can also determine the penetration depth of the object 8, 13. Thus, changes in the movement of the object 8, 13 in the hazardous area can also be detected. As soon as the object 8, 13 moves in the direction of the source of the hazard, such as the chains 15, if there is an acute risk of injury, the printing press 10 is switched off.

In an embodiment according to FIG. 3, the sensor 40 being used is a light barrier 41 which, just like the sensor 40, is connected through communications connections 6 to the machine control system 5 of the printing press 10. The light barrier 41 covers the entire opening 2 of the delivery 1 with its light beams, so that the operating personnel cannot penetrate into the interior of the delivery past the light beams. Therefore, the opening 2 constitutes a safeguarded area 44 which is monitored for a penetration of objects 8, 13. In this case, the light beams of the light barrier 41 are generated by light-emitting diodes 42 disposed on one side of the light barrier, in order to be registered on the opposite side by photodiodes 43. As soon as an object or a person wishes to penetrate into the hazardous area, one or more light beams are interrupted, so that no more light falls onto the corresponding photodiode 43. In this way, it is possible to determine which of the light beams has actually been interrupted. The penetration of a hand 8 of the operating personnel in this case interrupts fewer light beams than the penetration or removal of the entire delivery stack 13. If the operator puts his or her hand 8 through the opening 2 into the delivery 1, at least one of the light beams of the light barrier 41 is interrupted. The position of this light beam is transmitted to the machine control system 5, which then takes appropriate measures on the basis of the determined position of the light beam. If the penetration of this light beam does not represent a potential risk of injury, the machine control system 5 does not stop the printing press 10 or the delivery 1 and, instead, can output an acoustic or optical warning signal. However, if the hand 8 of the operator interrupts a light beam behind which an immediate risk of injury threatens, the machine control system 5 outputs a corresponding command to the drive of the printing press 10, which is then stopped immediately. In this way, the light barrier 41 with light beams that can be evaluated individually makes it possible to evaluate the safeguarded area 44 of the opening 2 as a function of location. In this case, depending on the machine state, a distinction is drawn as to whether the covering of a light beam by a penetrating object leads to a hazardous situation or not. For instance, if the gripper chains 15 in the delivery 1 are not moving, then an interruption of the light beams in the upper area of the delivery 1 does not lead to a machine stoppage. However, if a hazard is threatened by the delivery stack 13, because it is likewise in the upper area, then an interruption of the same light beam leads to a machine stoppage. Taking the operating state of the machine into account permits improved availability of the machine, since it is only necessary to switch off the machine when it is absolutely necessary.

This application claims the priority, under 35 U.S.C. §119, of German Patent Application 10 2004 055 229.0, filed Nov. 17, 2004; the entire disclosure of the prior application is herewith incorporated by reference.

We claim:

1. A method for safeguarding hazardous areas in machines, which comprises the following steps:
monitoring a hazardous area with at least one sensor for identifying objects penetrating into the hazardous area;
identifying, with the at least one sensor, when an object penetrates into the hazardous area;
providing communication between a machine control system and the at least one sensor; and
acting on the state of the hazardous area of the machine with the machine control system on the basis of the identification and the respective operating state of the machine.

2. The method according to claim 1, which further comprises carrying out the monitoring step by distinguishing between human body parts and objects with the sensor.

3. The method according to claim 1, which further comprises carrying out the monitoring step by three-dimensionally scanning the object penetrating into the hazardous area with the at least one sensor.

4. The method according to claim 3, wherein the at least one sensor is a 3-D camera.

5. The method according to claim 1, wherein the at least one sensor is a light barrier or a light curtain.

6. The method according to claim 1, which further comprises acting on hazardous parts of the machine in the hazardous area, with the machine control system.

7. The method according to claim 1, which further comprises placing hazardous parts of the machine in the hazardous area into a safe state, with the machine control system.

8. The method according to claim 1, which further comprises safeguarding the hazardous area with the machine control system acting on the basis of penetration movement of the identified object determined by the at least one sensor.

9. The method according to claim 8, which further comprises acting on the hazardous area with the machine control system on the basis of a determined penetration speed of the identified object.

10. The method according to claim 1, which further comprises safeguarding the hazardous area with the machine control system acting on the basis of shape of the identified object detected by the at least one sensor.

11. An apparatus for safeguarding hazardous areas in machines, the apparatus comprising:
at least one sensor monitoring the hazardous area for identification of objects penetrating into the hazardous area, said at least one sensor identifying when an object penetrates into the hazardous area; and
a machine control system communicating with said at least one sensor, said machine control system acting on the state of the hazardous area of the machine on the basis of the identification and the respective operating state of the machine.

12. The apparatus according to claim 11, wherein the machine is a printing press.
